(19) United States
(12) Patent Application Publication
(10) Pub. No.: US 2009/0073692 A1
(43) Pub. Date: Mar. 19, 2009

(54) Modular lighting system

(76) Inventors: Steve Berger, Massapequa, NY (US); Joseph Martino, JR., Bethpage, NY (US)

Correspondence Address: PANAGIOTA BETTY TUFARIELLO, ESQ.;INTELLECTULAW, THE LAW OFFICES OF P.B. TUFARIELLO, P.C., 25 LITTLE HARBOR ROAD, MOUNT SINAI, NY, 11766, US

(21) Appl. No.: 12/079,562

(22) Filed: Mar. 27, 2008

Related U.S. Application Data
(60) Provisional application No. 60/908,192, filed on Mar. 27, 2007.

(51) Int. Cl. F21V 21/00

(52) U.S. Cl. 362/249.02

(57) ABSTRACT

A modular, expandable lighting system comprising at least one light emitting diode segment having at least one printed circuit board, at least one light emitting diode and at least one pair of terminals connected to said printed circuit board and means for fixedly but removable fastening and mounting said light emitting diode segment with ease in tight spaces.

### BACKGROUND OF THE INVENTION

1. Field of the Invention.

This invention is directed towards a modular, light emitting diode (LED) assembly for use as streamlined, low profile lighting in bookcases, office hutches, under cabinets, boat and car interiors and any other venue needing longer life, high efficiency, low heat, discrete lighting. More particularly, the invention relates to a modular, LED bearing, lighting system designed to be easily mounted and affixed in narrow, short height, difficult-to-get-into, dark areas and venues, that need lighting, with minimum hardware, without any modifications that might mar or ruin the appearance of such venues and with minimum use of tools. The inventive, modular LED bearing tape light is easily expandable to accommodate any configuration that needs safe, longer life, efficient and heat dissipating lighting.

2. Related and Prior Art Statement

Instances arise when it becomes necessary to provide lighting to dark, narrow, short-height spaces and venues such as bookcases, kitchen cabinets (both inside and under), china closets, office hutches, luxury vans, closets, boats, etc. The lighting can become necessary for aesthetic or decorative purposes, as for example when it is needed to provide warm decorating accents. Or, the lighting can become necessary for utilitarian purposes as for example when lighting is necessary to illuminate the books contained in a bookcase, or to create additional work space on a kitchen counter, right underneath kitchen cabinets. What ever the reason for the necessity of lighting, failure to provide it, renders dark, narrow, short-height spaces and venues useless and joyless.

Apparatus and equipment that can provide lighting to dark, narrow, short-height spaces and venues include lamps, whether temporary or permanent in nature, incandescent or flurescent, and “puck lights.” Many of these apparatus and equipment are publicly available in both retail and wholesale selling establishments, described in advertising, magazines, and books and even disclosed in numerous patents.

One example of lighting for bookcases that is disclosed in a patent, is Lin, U.S. Pat. No. 6,478,443 B2. Such patent is directed to a bookcase lamp which comprises a seat, a lamp, and a switch. The seat is a casing with a flat and long shape and is assembled by a box, a lamp, and a base. The lamp is installed on the seat. The switch is installed on the seat for controlling opening and closing of the lamp. Therefore, the bookcase lamp can be placed in a bookcase like a book. As the user searches a book, the bookcase lamp will provide illumination.

Examples of under cabinet lighting systems that are also disclosed in patents, are: Benensohn, U.S. Pat. No. 6,431,722 B1; Bohler, U.S. Pat. No. 6,641,283 B1; Compagnucci, U.S. Patent Application Publication No. U.S. 2001/0036070 A1; Fiene, U.S. Pat. No. 6,814,462 B1; Miller, U.S. Pat. No. 4,908,743; Palka, U.S. Pat. No. 4,058,718; Roorda, U.S. Pat. No. 6,508,566 B1; and Sanborn, United States Patent Application Publication No. U.S. 2005/0190580.

Benensohn, U.S. Pat. No. 6,431,722 B1 is directed to an under-cabinet lighting fixture for permanent mounting, having a housing suitable for recess or surface mounting, and connected by a stem to a junction box mounted to an upper surface for electrical wiring connections. The stem defines a passageway for the electrical wiring to route from the housing to the junction box.

Bohler, U.S. Pat. No. 6,641,283 B1 is directed to a lighting assembly for improving the performance of under-cabinet and stream-lined lighting, which includes an LED module onto which is mounted a plurality of light emitting diodes (LEDs). The LEDs serve as the light source for generating a light pattern. An optical assembly focuses and disperses the LED output to a desired light contour. The lighting assembly further includes a mounting base for attaching the LED module to an associated surface, such as the underside of a cabinet. A battery source is optionally enclosed in the module for providing primary or secondary power to the lighting assembly. In a preferred embodiment, the battery source is a rechargeable battery that can be recharged by means of an AC adapter that connects to the lighting assembly.

Compagnucci, United States Patent Application Publication No. U.S. 2001/0036070 A1 is directed to a modular panel for wall fixing, capable of being assembled in a sequence and electrically connected with other manufactures of the same type, in order to decorate and light kitchen areas, especially in the space comprised between the wall cabinets and the counters of modular kitchen furniture. The panel consists in a square or rectangular metal sheet frame, frontally covered by a glass or transparent plastic plate, which acts as luminaire. The plate is supported by a bearing structure, represented by a metal sheet moulding. It contains the electrical contacts required to install and power the lamp. One the upward sections of the moulding frontally features the on/off switch for the lamp and one or more mains sockets for small kitchen households. Each side of the panel features a recessed housing for a female connector, of known type, it being provided that when the two panels are placed one next to the other, the connectors of the panels are connected, without intermediate spaces, by means of a male recessed coupling, also of known type. This allows for connecting the luminous panels in series, by connecting one panel to the mains, which supplies all the other panels in the sequence. Pressure covers are present to provide the surface continuity of the sides of the mouldings and avoid seeing the holes that house the female connectors located on the free sides of the first and last panel of a continues series.

Fiene, U.S. Pat. No. 6,814,462 B1 is directed to a low cost under-cabinet and display case lighting system that permits the highest degree of flexibility in the installation and location of luminaires for under-cabinet and display case lighting. The system consists of a high-frequency power source, an interconnection cord, and one or more high-frequency luminaires. The high-frequency power source is powered from a source of 50 or 60 Hertz power. The interconnection cord is connected to the high-frequency output of high-frequency power source. The high-frequency luminaires are mounted in the desired locations under the cabinets or display case shelves. The interconnecting cord is then routed to each of the high-frequency luminaires and placed over the input terminals. The protective cover is then forced over the interconnecting cord in the area of the input terminals forcing the input terminals to pierce and displace the insulation of the cord and make contact with the conductors within the interconnecting cord. Any number of additional high-frequency luminaires (within the capacity of the high-frequency power source) may be added in the same manner.

Miller, U.S. Pat. No. 4,908,743 is directed to a low voltage strip lighting assembly has an elongated flexible insulator strip having a base including two sides and a top surface having elongated slits that retain flat electrical conductors. A miniature wire terminal lamp bulbs are adjacent to the top surface of the insulator strip with terminals extending from the top surface of the insulator strip into a slit in the insulator strip to electrically contact one side surface of a respective flat conductor at any point along the length of the insulator strip, whereby the application of electrical power from an external source to each of the respective conductors will light the bulbs. A generally U-shaped lens covers the light bulbs and has legs engaging the sides of the insulator and inwardly-biased and secured to the insulator by the engagement of ribs into matching grooves in the insulator.

Palka, U.S. Pat. No. 4,058,718 is directed to a soffit lighting fixture removably secured above and associated with a wall cabinet generally referred to as a medicine cabinet, which is fixed above the washbasin with or without the vanity base. The lighting fixture supplies light above and around the foregoing basin.

Roorda, U.S. Pat. No. 6,508,566 B1 is directed to an under cabinet halogen light fixture with an internal wire raceway. It includes a housing having a base and a removable cover, which when mated, define a hollow interior. The light fixture also includes at least one lamp assembly mounted inside the housing. Adjacent each lamp assembly there is a corresponding bezel assembly mounted in a respective aperture formed in the cover. A wall member located in the base defines at least one internal wire raceway in the interior of the housing, which routes electrical wires to each lamp assembly from an external wire raceway, or from a hole in the base of the housing where the electrical wires enter the housing. If needed, the hole in the base of the housing is created by removing a punch out portion from the base. To mate the internal wire raceway with an external wire raceway, a breakaway portion formed in the housing adjacent the internal wire raceway is removed from the housing to create a passageway that is shaped to receive the external wire raceway. A tongue shaped for insertion into the external wire raceway is formed in the housing adjacent the breakaway portion to connect the internal wire raceway with the external wire raceway.

As for Sanborn, United States Patent Application Publication No. U.S. 2005/0190580, it is directed to an under-cabinet lighting fixture includes xenon bulbs and/or halogen bulbs of less than about 35 watts contained within a housing that is devoid of any dedicated heat dissipation back vents on the back or top of the lighting unit. A top cover is connected to a wire-containing channel of the unit, with such cover being removable during wiring and mounting operations by removing screws locking the cover into place. The unit is further devoid of any dedicated reflectors and instead relies upon the reflective coating applied to the interior of the housing unit itself, which acts as a mirrored surface to reflect the bulb's illumination. A single glass lens is supported by a metal frame that runs around the periphery of such lens and the lens cover itself is connected to the housing by pivoting hinges and is snap locked into place by flexible metal/plastic elements that are configured to lock into apertures within the housing. Such a lens cover locking feature eliminates the need to use any separate screw locking feature of prior art designs, thus adding to the sleek appearance of the present lighting unit. Both hard wired and plug-in models are included, with the plug-in units having male and female molex connectors to allow such units to be linked together with extensions.

The apparatus and equipment that can provide lighting to dark, narrow, short-height spaces and venues, as set forth and described herein above, are not amenable to use and installation by an inexperienced user, or an installer with minimum experience. They all require knowledge of mounting the equipment directly onto the cabinets or bookcases, among other things, a knowledge that must include knowledge of using the appropriate drill, drill bits, washers and screws. They also require substantial strength for the drilling of the necessary appertures into the cabinetry for the proper mounting and installation of the apparatus and equipment. Finally, they mandate the sacrifice of the outward appearance of the cabinetry since it is necessary for the proper mounting of the apparatus and equipment to drill holes and secure screws, the removal of which, upon dismount of the apparatus and equipment from the cabinetry will leave holes that will either require the patching and refinishing of the cabinetry, particularly if the holes are visible or the replacement of the cabinetry itself.

In addition, the installation of the apparatus and equipment set forth hereinabove by inexperienced users can cause a whole host of hazards. When inexperienced users wish to install under cabinetry lighting, they go out to buy goods that are line voltage items, i.e., they purchase 120 volts alternating current lighting to install by themselves. They install it themselves. They use lamp cord. They do not wire it according to code a lot of them don't know about voltage drops. Or they will put too much on one circuit causing an overload. Such overloads cause tremendous heat and may lead to fires. The heat generated will ruin the cabinetry in connection with which it is being used. It is not unusual to see heat marks on a hutch or in a bookcase.

The alternative of course, is to have an electrician install the apparatus and equipment set forth hereinabove. Electricians however, are prohibitively costly. Thus, with the current trend of “do it yourself homeowners,” the inexperienced installers will insist on doing the job themselves, albeit incorrectly and against code, and not hire a professional.

Finally, with the exception perhaps of “puck” lights, the apparatus and equipment both set forth hereinabove and described in the public domain, are very bulky, and very hard to run the wiring for. Fluorescent lighting in turn, has transformers in it which can drip. and the ballast takes the brunt of the abuse.

### SUMMARY OF THE INVENTION

A modular lighting system comprising at least one light emitting diode segment having at least one printed circuit board, at least one light emitting diode and at least one pair of terminals connected to said printed circuit board and means for fixedly but removable fastening and mounting said light emitting diode segment with ease in tight spaces.

### BRIEF DESCRIPTION OF THE DRAWINGS

While the specification concludes with claims which particularly point out and distinctly claim the present invention, it is believed that the present invention will be better understood from the following detailed description taken in conjunction with the accompanying drawings in which like numerals represent identical elements and wherein:

FIG. 1 is a three dimensional perspective view of the inventive device lit and in use;

FIG. 2 is a three dimensional view of an installation showing the inventive device as mounted and used in a bookcase;

FIG. 3 are top and side plan views of the inventive device;

FIG. 4 is an anatomical three dimensional perspective view of the inventive device;

FIG. 5 is a top view of the inventive device of FIG. 4;

FIG. 6 is a side view of the inventive device of FIG. 4;

FIG. 7 is a perspective of one switch, i.e, a plunger switch used with the inventive dev ice;

FIG. 8 is a bottom view of the switch of FIG. 7;

FIGS. 9-10 are top views and side view of the inventive device with cover aka blinder;

FIG. 11 is a sectional view of the ends of the inventive device taken along one of its terminal end showing the arrangement of the blinder at the terminal ends;

FIG. 12 is a top plan view of the device connected to a PCB switch board equipped with a plunge switch;

FIG. 13 is a three-dimensional perspective of yet another embodiment of the inventive device;

FIG. 14 is an exploded perspective view of the inventive device of FIG. 13 showing the terminal connection devices;

FIGS. 15-18 are exploded perspective views of yet other embodiments of the inventive device of FIG. 13 showing the terminal connection devices;

FIGS. 19-20 are perspective, exploded views of the PCB switch board for use in connection with the inventive device;

FIG. 21 is a perspective of the inventive device showing the u-shaped terminal receiving ends;

FIG. 22 is a an exploded perspective view of the inventive device of FIG. 21;

FIG. 23 is a sideview of the inventive device of FIG. 21;

FIG. 24 is a top view of the inventive device of FIG. 21;

FIG. 25 is a top view of a longer version of the inventive device of FIG. 25 FIG. 26-27 is a diagrammatic explanation of layout, preparation and installation of the inventive device.

### DETAILED DESCRIPTION

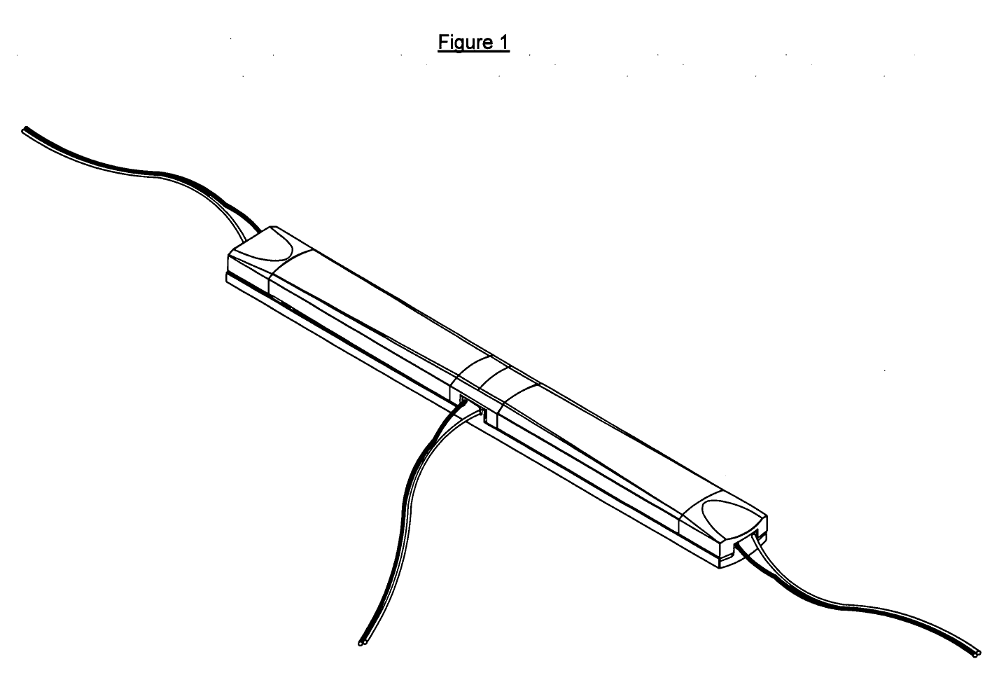

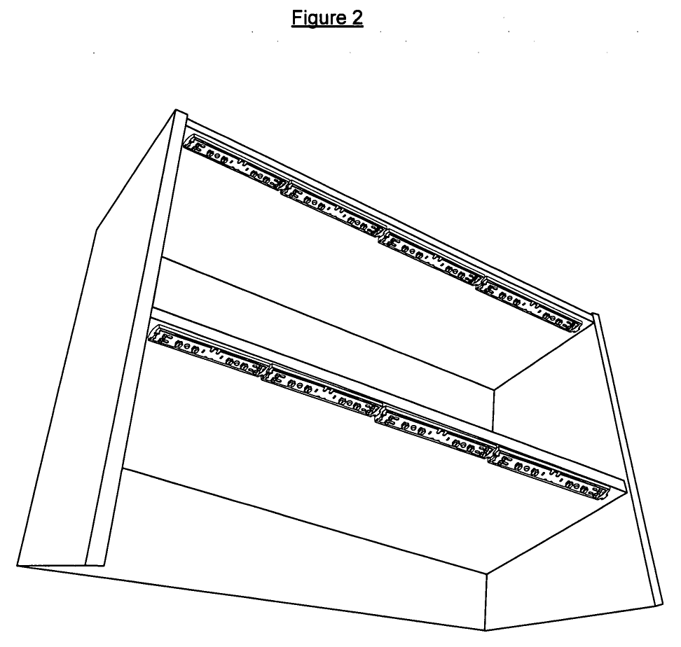

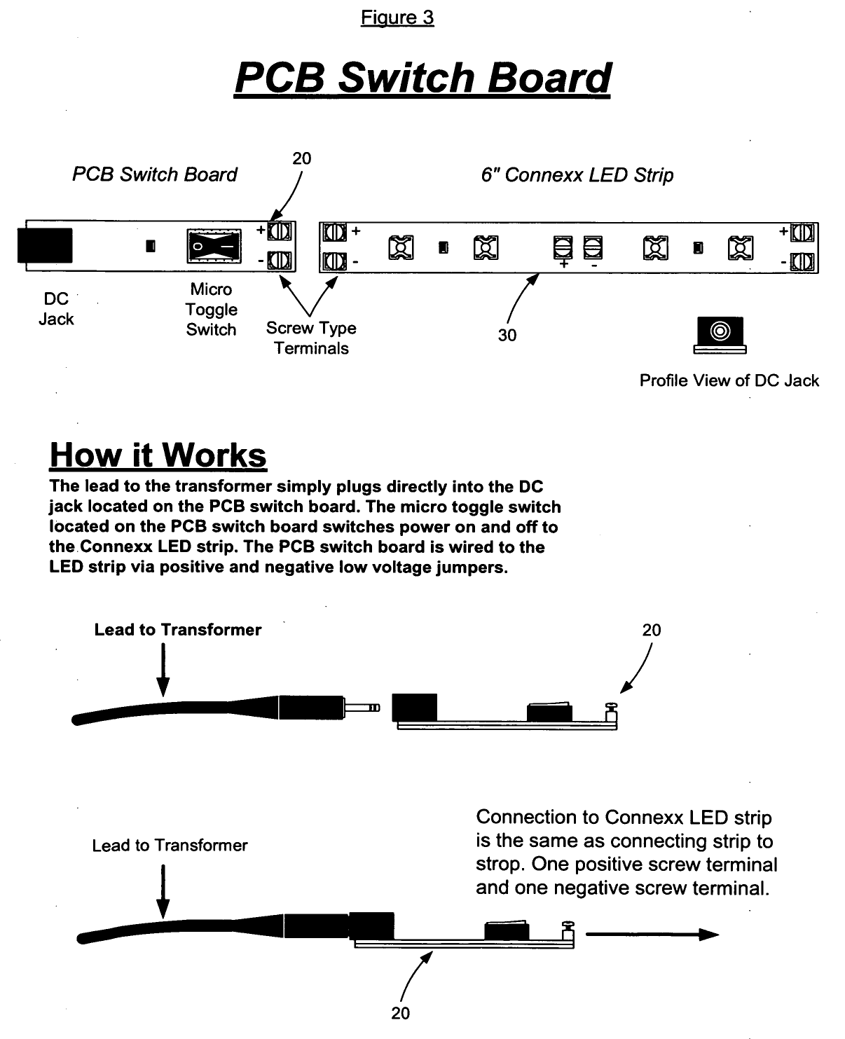

Referring more specifically to the drawings, FIG. 1 and FIG. 2 generally depict the inventive device, i.e. the Modular Lighting System (hereinafter “the Device”) at 10. It is designed to have a stream-lined low profile while at the same time be able to provide abundant, longer life, more efficient, less heat-generating lighting in tight dark spaces, such as bookcases, office hutches, under cabinets, interiors of boats, and cars. It is installable without the use of any hardware and with minimum use of tools. It is easily expandable and can be tailored to accommodate any configuration and provide light in any application.

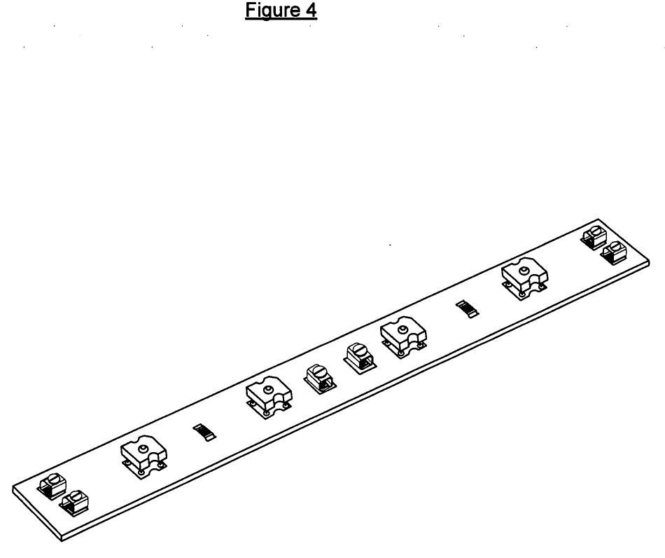

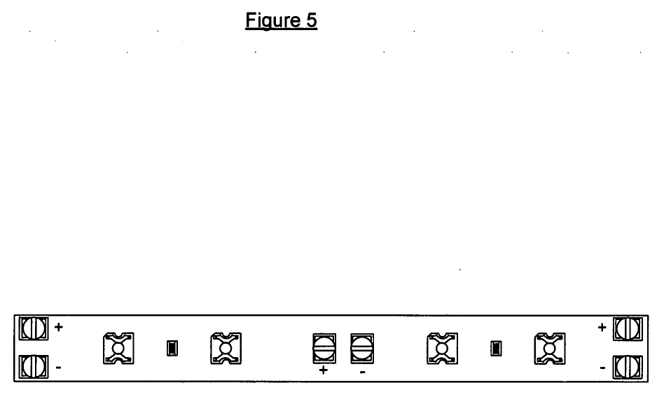

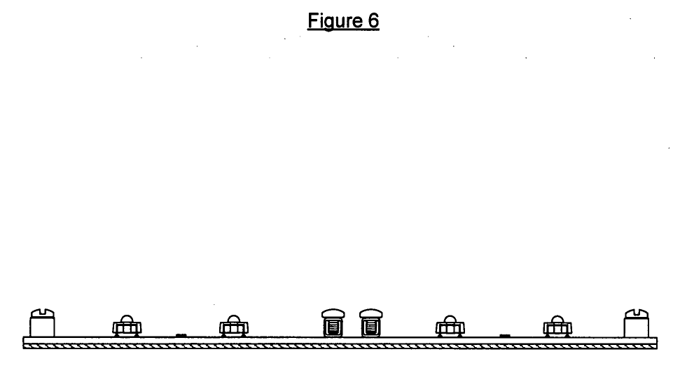

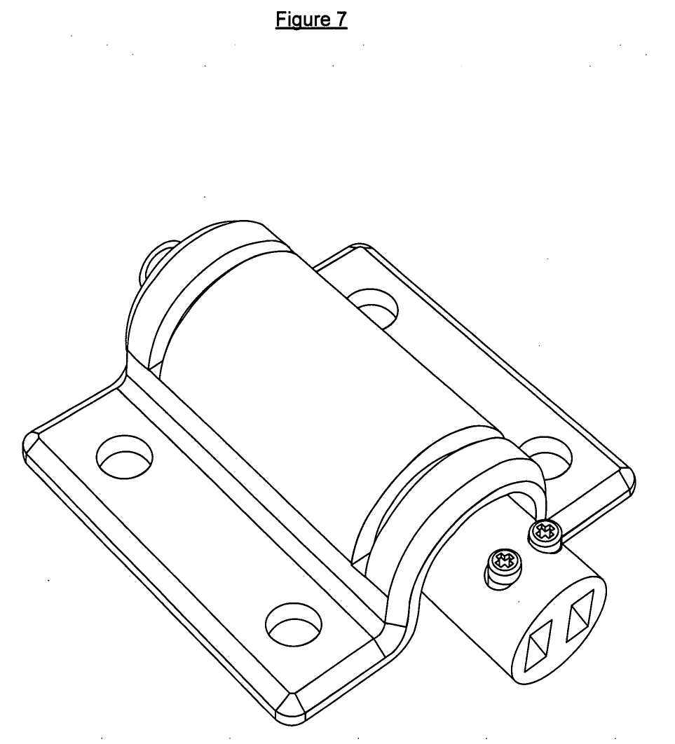

In its simplest form, which appears in FIG. 3, the Device 10 comprises at least one PCB switch board 20, and at least one Light Emitting Diode (hereinafter “LED”) segment 30. As can be seen from FIG. 4, FIG. 5 and FIG. 6, the LED segment 30 comprises a printed circuit board (PCB) strip 40, at least one LED 50 and at least one pair of terminals 60 fixedly mounted on the top side of the PCB strip 40; and fastenting means such as tape 70, on the side opposite to the LED and terminal bearing side of said PCB Strip 40.

The PCB strip 40 is a relatively thin strip. It comprises conductive pathways, or traces etched from copper sheets laminated onto a non-conductive substrate. A trace on a printed circuit board is the equivalent of a wire for conducting signals or current. Each trace consists of a flat, narrow part of the copper foil that remains after etching.

The PCB strip 40 may be composed of between one and twenty four conductive layers separated and supported by layers of insulating material i.e. substrates, laminated together, ie. glued with heat, pressure and sometimes vacuum. The layers may be connected together through drilled holes called vias. To form an electrical connection the holes are either electroplated or small rivets are inserted. Even though they may not form electrical connections to all layers these holes are typically drilled completely through the PCB.

There are many ways that the conductive traces can be placed on the printed circuit board. They can be made by adhering a layer of copper over the entire substrate, sometimes on both sides, (creating a “blank PCB”) then removing or “subtracting” unwanted copper after applying a temporary mask (eg. by etching), leaving only the desired copper traces.

There are three common “subtractive” methods (methods that remove copper) used for the production of printed circuit boards: (i) silk screen printing uses etch-resistant inks to protect the copper foil. Subsequent etching removes the unwanted copper. Alternatively, the ink may be conductive, printed on a blank (non-conductive) board; (ii) Photoengraving uses a photo-mask and chemical etching to remove the copper foil from the substrate. The photo-mask is usually prepared with a photoplotter from data produced by a technician using CAM, or computer-aided manufacturing software. Laser-printed transparencies are typically employed for phototools; however, direct laser imaging techniques are being employed to replace phototools for high-resolution requirements; and (iii) PCB milling uses a two or three-axis mechanical milling system to mill away the copper foil from the substrate. A PCB milling machine (referred to as a ‘PCB Prototyper’) operates in a similar way to a plotter, receiving commands from the host software that control the position of the milling head in the x, y, and (if relevant) z axis. Data to drive the Prototyper is extracted from files generated in PCB design software and stored in HPGL or Gerber file format.

Alternatively, the conducting traces can be placed on the PCB by adding traces to the bare substrate (or a substrate with a very thin layer of copper) usually by a complex process of multiple electroplating steps. The most common “additive” process is the “semi-additive” process. In this version, the unpatterned board has a thin layer of copper already on it. A reverse mask is then applied. (Unlike a subtractive process mask, this mask exposes those parts of the substrate that will eventually become the traces.) Additional copper is then plated onto the board in the unmasked areas; copper may be plated to any desired weight. Tin-lead or other surface platings are then applied. The mask is stripped away and a brief etching step removes the now-exposed original copper laminate from the board, isolating the individual traces. The additive process is commonly used for multi-layer boards as it facilitates the plating-through of the holes (vias) in the circuit board.

The Holes, or vias, through a PCB are typically drilled with tiny drill bits made of solid tungsten carbide. The drilling is performed by automated drilling machines with placement controlled by a drill tape or drillfile. These computer-generated files are also called numerically controlled drill (NCD) files or “Excellon files”. The drill file describes the location and size of each drilled hole.

When very small vias are required, drilling with mechanical bits is costly because of high rates of wear and breakage. In this case, the vias may be evaporated by lasers. Laser-drilled vias typically have an inferior surface finish inside the hole. These holes are called micro vias.

It is also possible with controlled-depth drilling, laser drilling, or by pre-drilling the individual sheets of the PCB before lamination, to produce holes that connect only some of the copper layers, rather than passing through the entire board. These holes are called blind vias when they connect an internal copper layer to an outer layer, or buried vias when they connect two or more internal copper layers.

The walls of the holes, for boards with 2 or more layers, are plated with copper to form plated-through holes that electrically connect the conducting layers of the PCB. For multilayer boards, those with 4 layers or more, drilling typically produces a smear comprised of the bonding agent in the laminate system. Before the holes can be plated through, this smear must be removed by a chemical de-smear process, or by plasma-etch.

The pads and lands to which components will be mounted are typically plated, because bare copper oxidizes quickly, and therefore is not readily solderable. Traditionally, any exposed copper was plated with solder. This solder was a tin-lead alloy, however new solder compounds are now used to achieve compliance with the RoHS directive in the EU, which restricts the use of lead. Other platings used are OSP (organic surface protectant), immersion silver, electroless nickel with immersion gold coating (ENIG), and direct gold. Edge connectors, placed along one edge of some boards, are often gold plated.

Areas that should not be soldered to may be covered with a polymer solder resist (solder mask) coating. The solder resist prevents solder from bridging between conductors and thereby creating short circuits. Solder resist also provides some protection from the environment.

After the PCB is completed, the remaining electronic components will be fixedly attached to form a functional printed circuit assembly, or PCA. In through-hole construction, the component leads may be inserted in holes and electrically and mechanically fixed to the board with a molten metal solder, while in surface-mount construction, the components are simply soldered to pads or lands on the outer surfaces of the PCB.

Often, through-hole and surface-mount construction must be combined in a single PCA because some required components are available only in surface-mount packages, while others are available only in through-hole packages.

JEDEC guidelines for PCB component placement, soldering, and inspection are commonly used to maintain quality control in this stage of PCB manufacturing.

PCB laminate materials include FR-4, the most common PCB material; FR-2 ;Polyimide; GETEK; BT-Epoxy; Cyanate Ester; Pyralux, a material for flexible printed circuits; PTFE, Polytetrafluoroethylene; Rogers Bendflex and Conductive ink.

The PCB strip 40 has a distal side 42 and a proximate side 44. Multiple LEDs 50 are fixedly mounted on the distal side 42 of the PCB strip 40 using traditional methods of mounting components on a PCB, i.e., either via through hole construction or via surface mount construction. The number of LEDs 50 will depend on the length of the PCB strip 40, and on the area needing lighting. Obviously, the longer the PCB strip 40, the more the LEDs.

An LED is just a tiny light bulb that fits easily into the electrical circuit etched on the PCB. However, unlike ordinary incandescent bulbs, LEDs don't have ordinary filaments that will burn out and they don't get especially hot. They are illuminated solely by the movement of electrons in a semiconductor materials, and they last just as long as a standard transistor.

The advantage of using an LED is that it produces more light per watt than do incandescent bulbs; this is useful in battery powered or energy-saving devices. LEDs can emit light of an intended color without the use of color filters that traditional lighting methods require. This is more efficient and can lower initial costs. The solid package of an LED can be designed to focus its light. Incandescent and fluorescent sources often require an external reflector to collect light and direct it in a usable manner. When used in applications where dimming is required, LEDs do not change their color tint as the current passing through them is lowered, unlike incandescent lamps, which turn yellow. LEDs are ideal for use in applications that are subject to frequent on-off cycling, unlike fluorescent lamps that burn out more quickly when cycled frequently. LED's, being solid state components, are difficult to damage with external shock. Fluorescent and incandescent bulbs are easily broken if dropped on the ground. LEDs have an extremely long life span. One manufacturer has calculated the ETTF (Estimated Time To Failure) for their LED's to be between 100,000 and 1,000,000 hours. Fluorescent tubes typically are rated at about 10,000 hours, and incandescent light bulbs at 1,000-2,000 hours. LEDs mostly fail by dimming over time, rather than the abrupt burn-out of incandescent bulbs.

LEDs light up very quickly. A typical red indicator LED will achieve full brightness in microseconds; LEDs used in communications devices can have even faster response times.

LEDs can be very small and are easily populated onto printed circuit boards.

In the preferred embodiment, the LEDs 50 are 1.5 volt LEDs and are either optionally equipped with resistors that reduce the voltage delivered to them or the PCB strip 40 is optionally provided with resistors to reduce the voltage even further and prevent them from getting burned out.

Also fixedly mounted on the distal side 42 of the PCB strip 40 is at least one pair of electrical connectors or terminals 60. An electrical connector is a device for joining electrical circuits together. The connection may be termporary, as for portable equipment, or may require a tool for assembly and removal, or may be a permanent electrical joint between two wires or devices. A terminal is a simple type of electrical connector that connects two or more wires to a single connection point. Wire nuts are another type of single point connector.

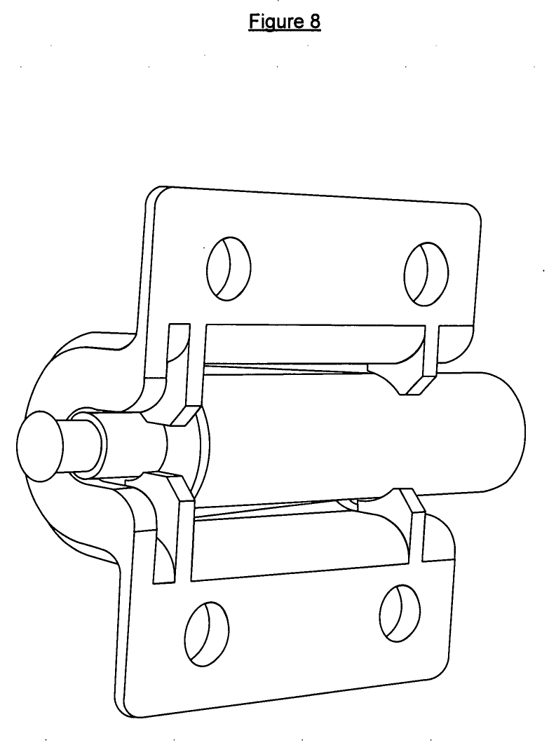

In the embodiment of the LED segment 30 shown in FIGS. 4, 5 and 6 the terminals 60 are conventional screw type terminals. However, they can also be more sophisticated screw type terminals of the type shown in FIGS. 7 and 8. These terminals accept wires that are prepared only by removing or stripping a short length of insulation from the end to allow individual wires to be connected to the PCB strip 40. The terminals 60 are soldered to the board.

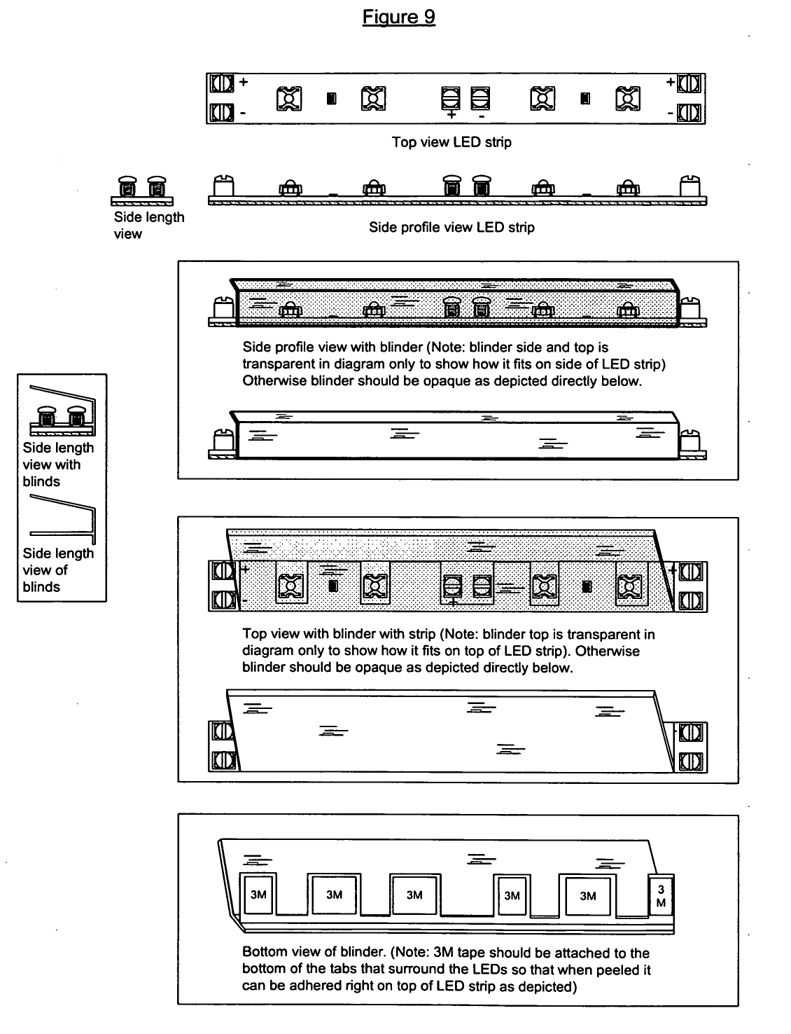

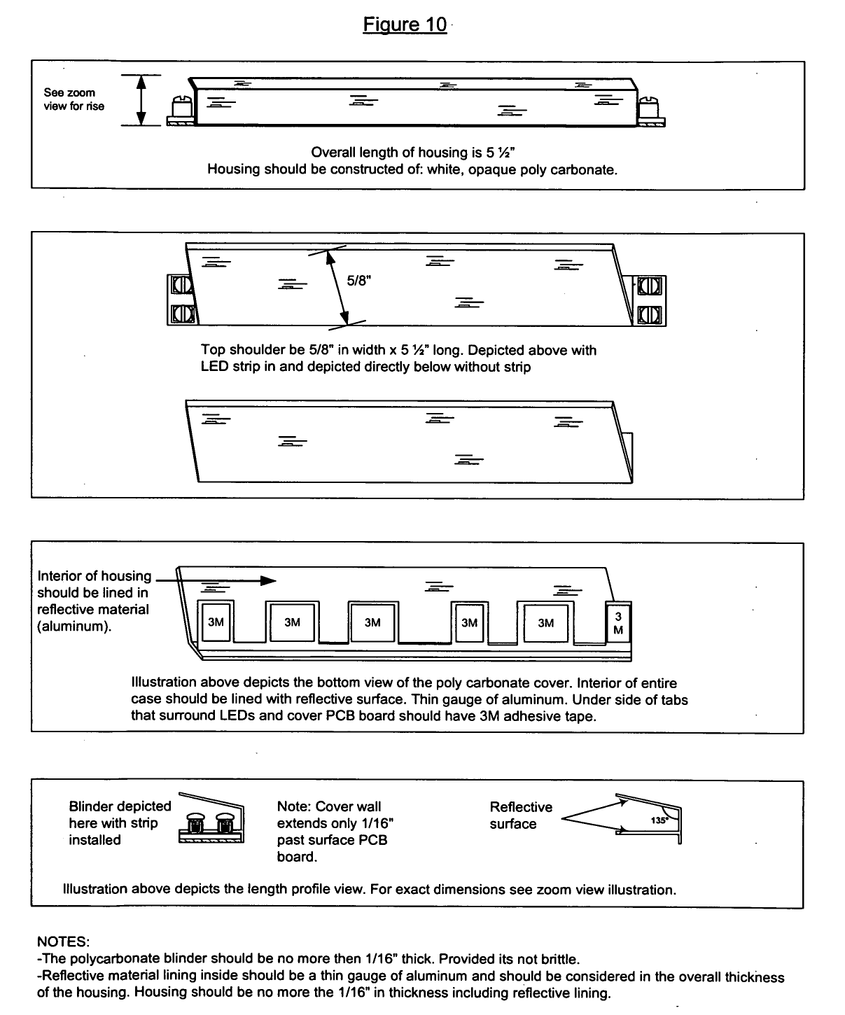

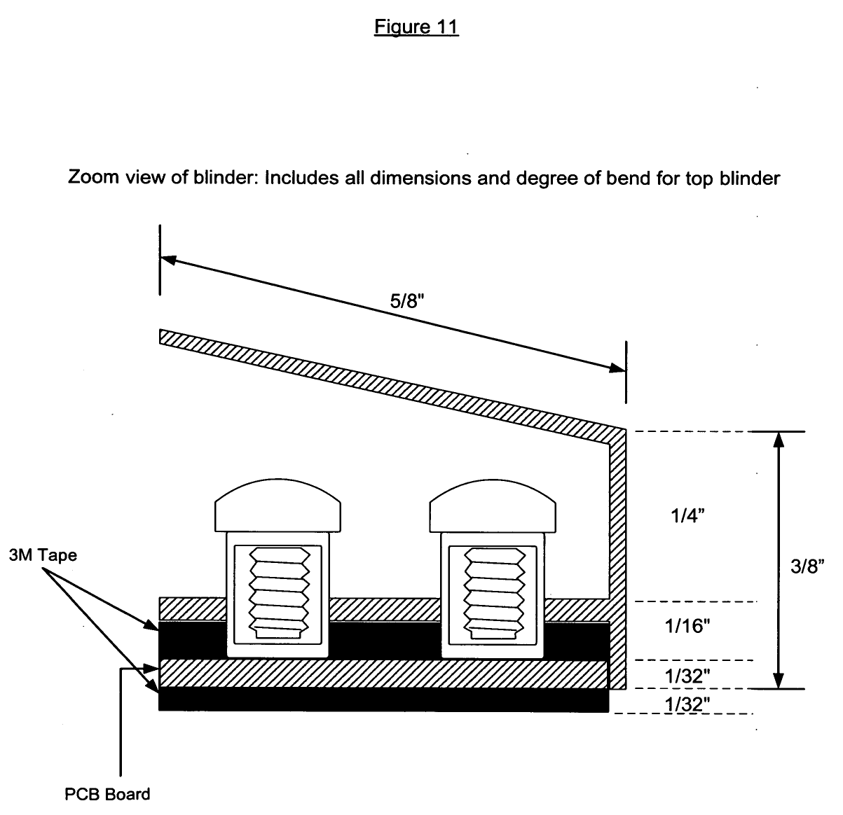

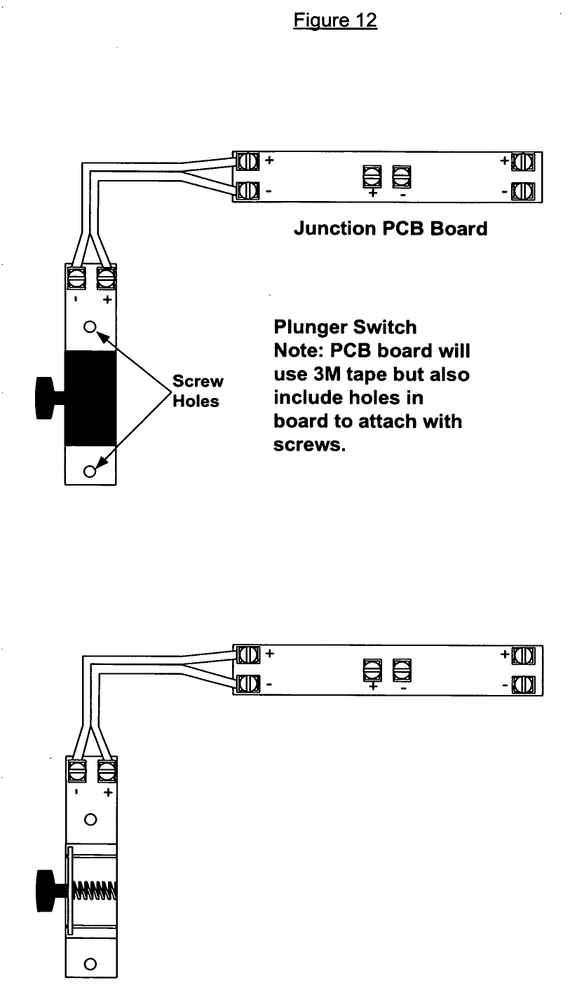

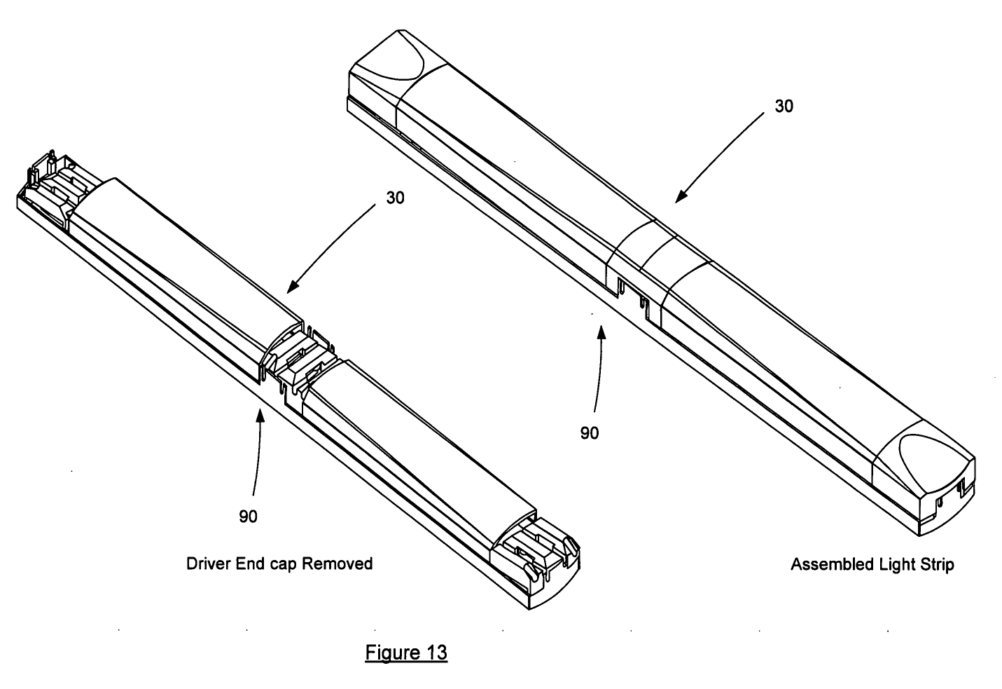

FIGS. 9, 10 and 11, show that the LED segment 30, can be optionally provided with a cover or blinder 80. The blinder 80 must be opaque, preferably of white poly-carbonate. The inner surface of the blinder 80, is lined with a reflective material such as thin gauge aluminum to increase the brightness of the LEDs 50, when lit up.

Finally, the proximate side 42 of the PCB strip 40 is provided with a tape 70, bearing a protective covering.

As can be seen from FIG. 3, the PCB Switch Board 20 also comprises a distal side 22 and a proximate side 24. Further, it comprises a first end 26 and a second end 28. Fixedly mounted on the first end 26 and on the distal side 22 is a DC Jack 23. Fixedly mounted on the second end 28 and on the distal side 22 is at least one pair of terminals 60. In between the terminals 60 and the DC Jack 23, on the distal side 22 is fixedly mounted a micro toggle switch 25. The lead from an electric current source such as a step-down transformer plugs into the DC Jack 23, while the cord from the step down transformer is plugged into an AC outlet.

The proximate side 24 is also provided with tape bearing a protective covering. The terminals 60 of the PCB switch board 20 are connected with two jumper wires 90 to the at least one pair of terminals 60 of the LED segment 30, positive terminal 60 of PCB Switch Board 20 to positive terminal 60 of LED segment 30, and negative terminal 60 of PCB Switch Board 20 to negative terminal 60 of LED segment 30. Thus, when the micro toggle switch 25 located on the PCB switch board opens or closes the circuit, it switches power on and off to the LED segment 30.

Upon connection of the PCB Switch Board 20 to the LED segment 30 the protective covering can be peeled off the proximate sides of both PCB Switch Board 20 and the LED segment 30 and the whole Modular Light System 10 can be installed and affixed to any surface in any space that needs lighting. If the area that needs lighting is inside a kitchen cabinet or a closet or any other enclosed dark space then the plunger switch of FIG. 12 can be added to the Device 10, so that it lights up automatically upon the opening of the door which will close the circuit, and shuts down automatically upon the closing of the door and the opening of the circuit.

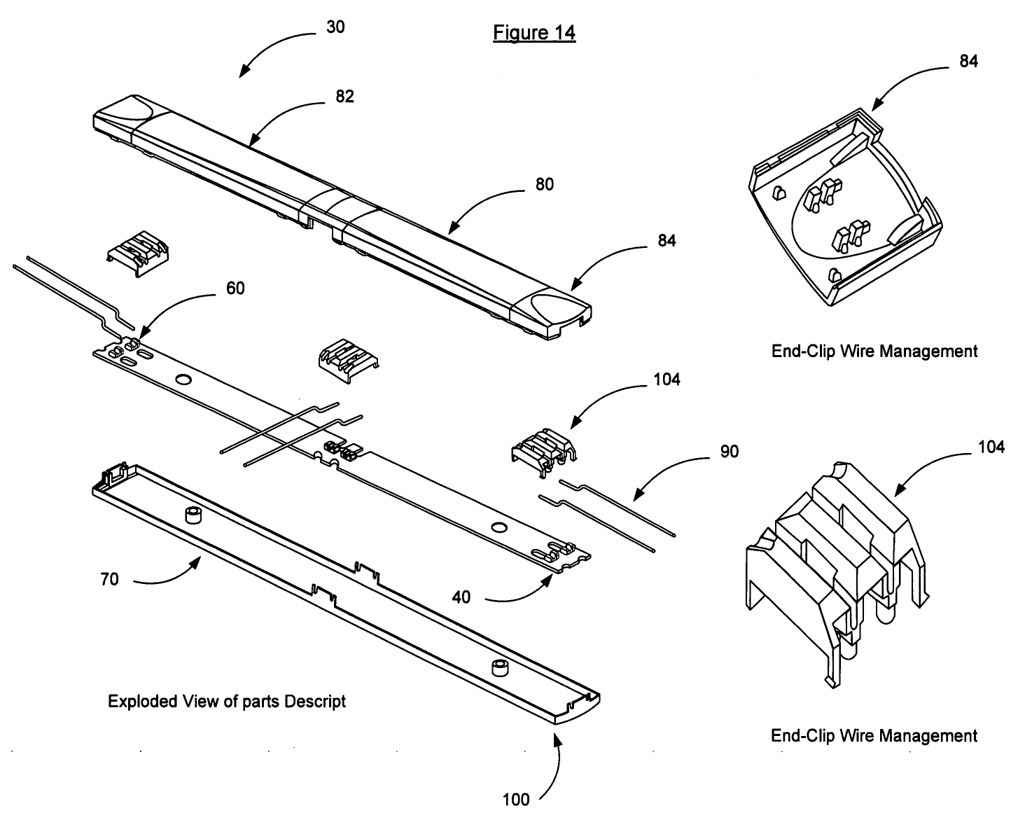

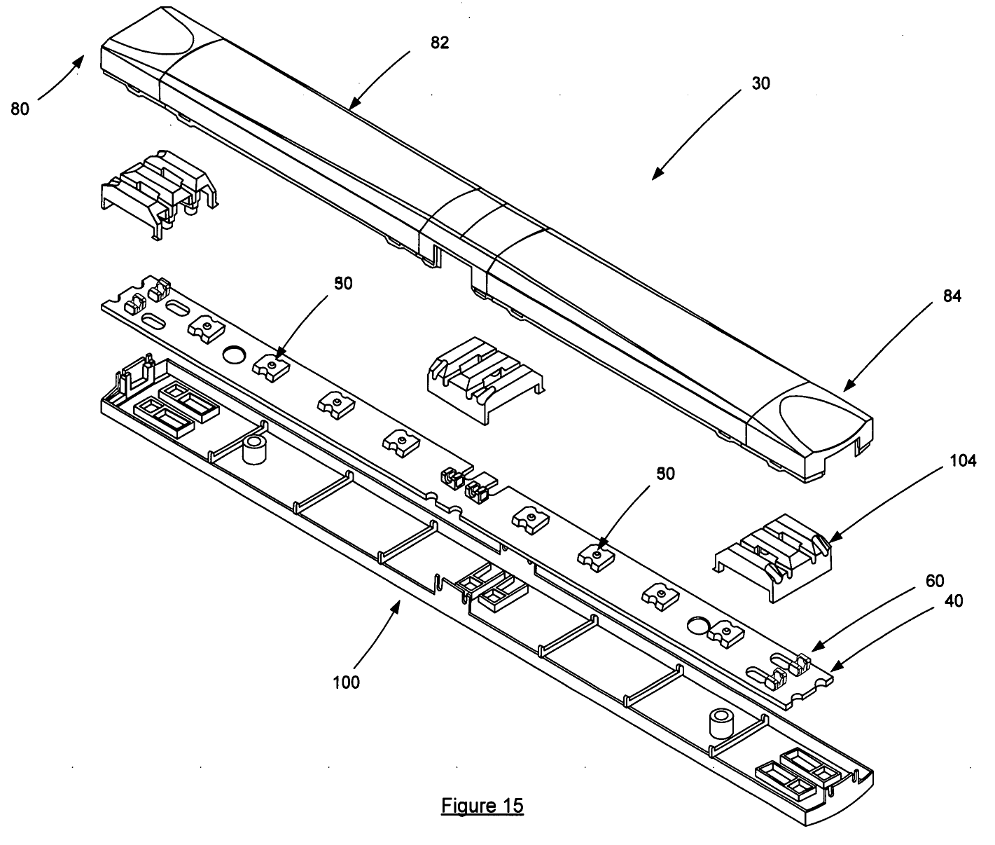

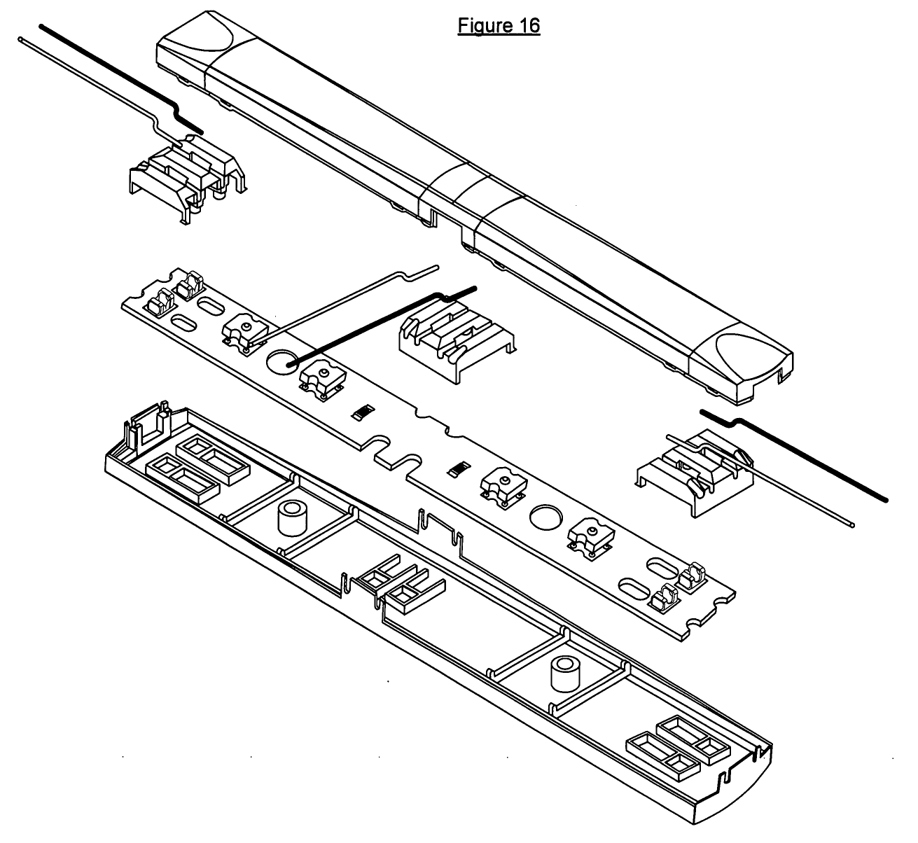

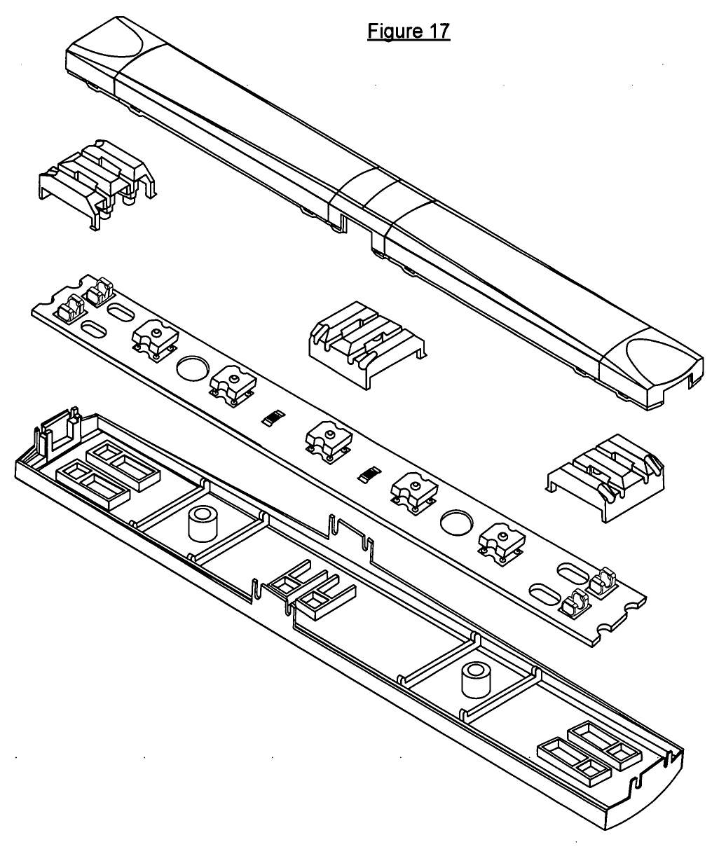

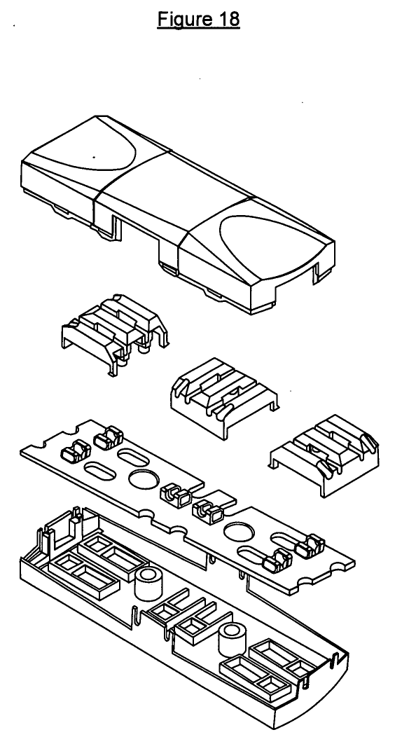

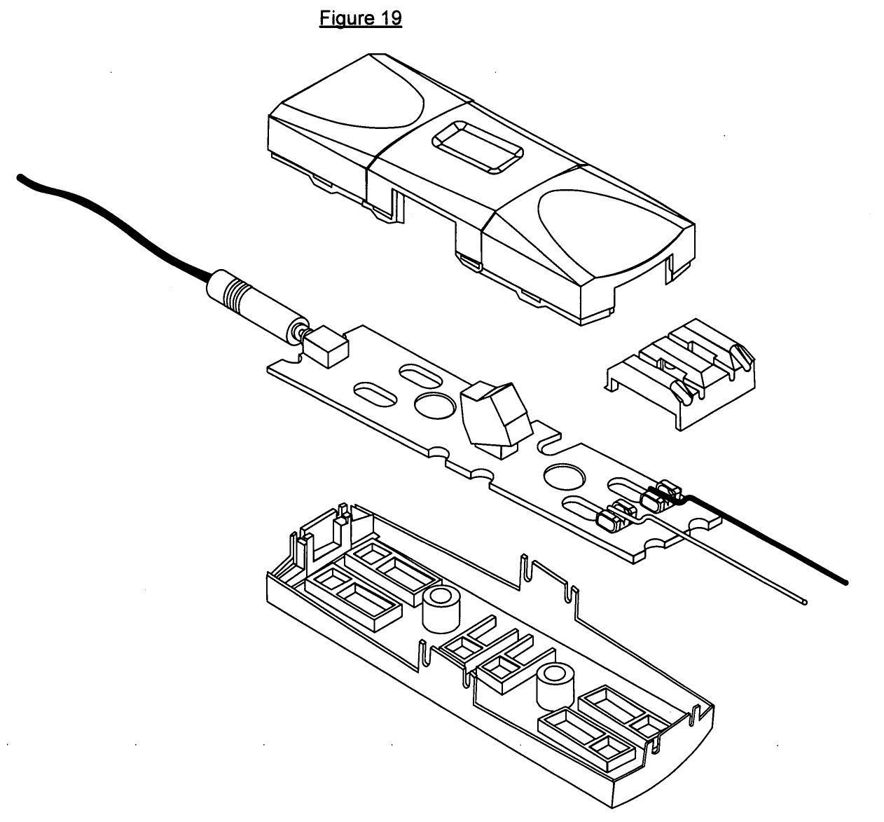

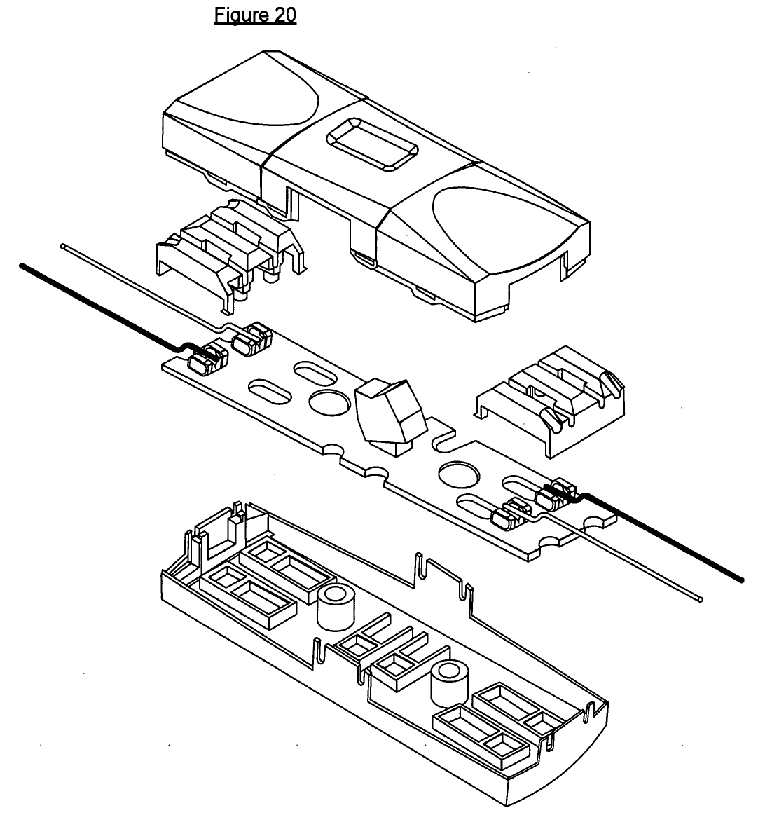

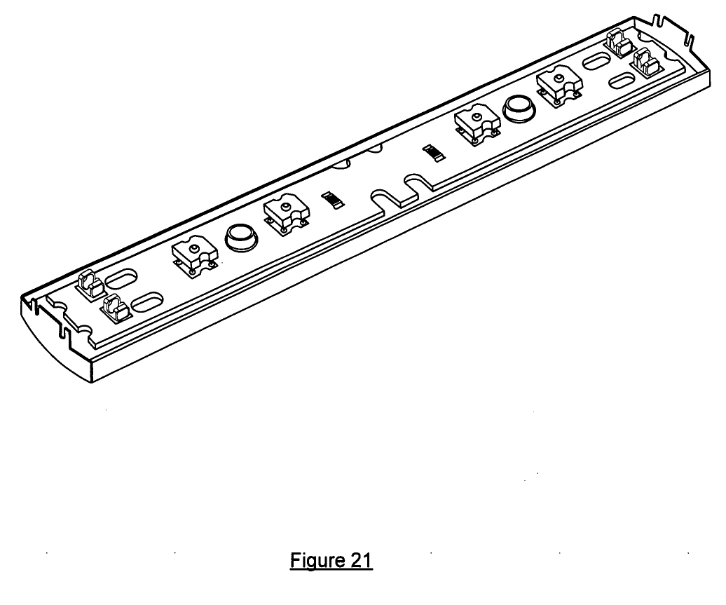

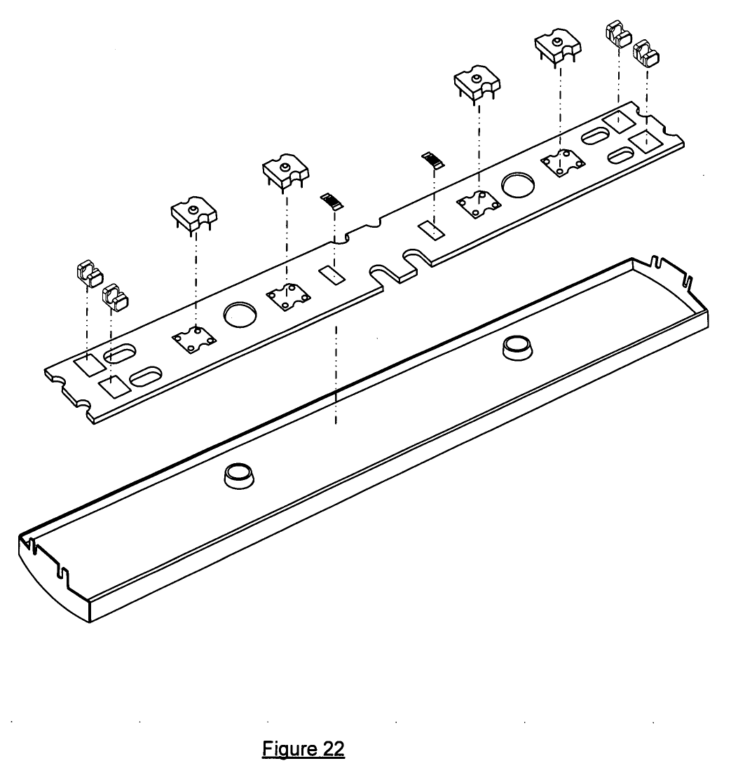

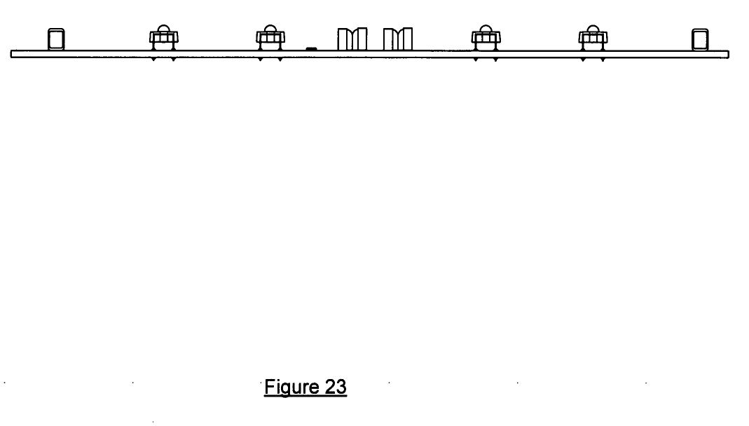

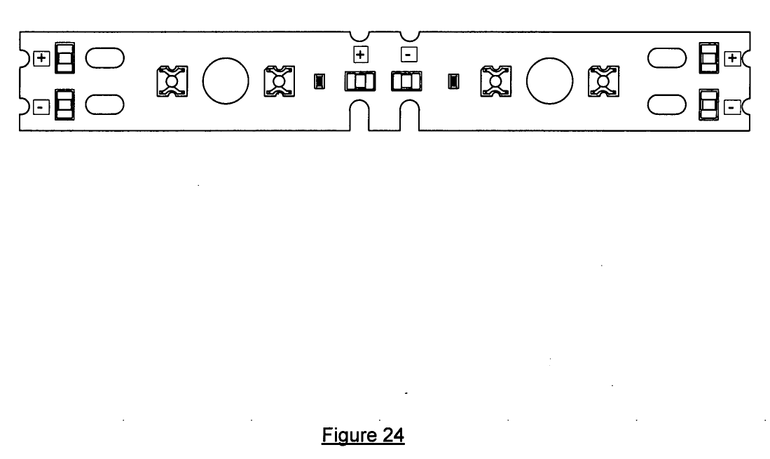

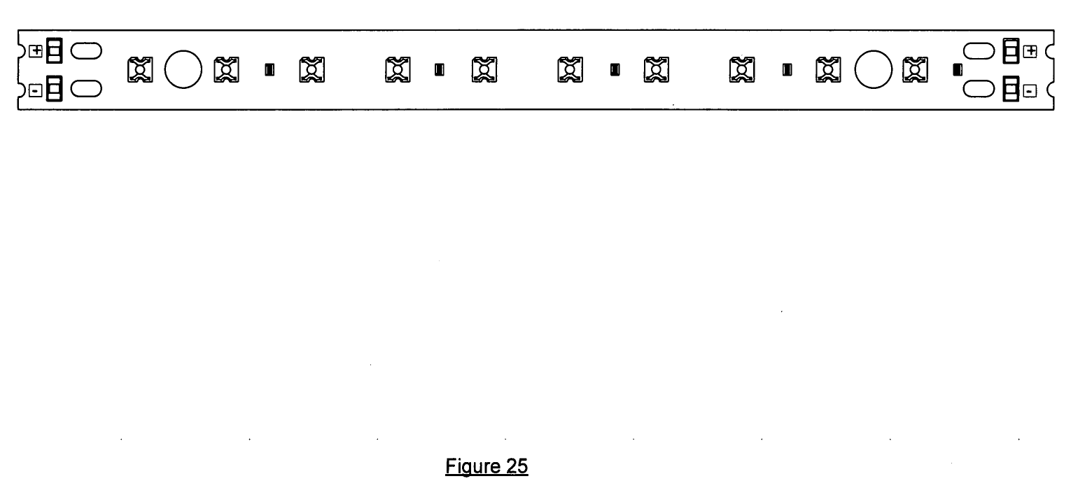

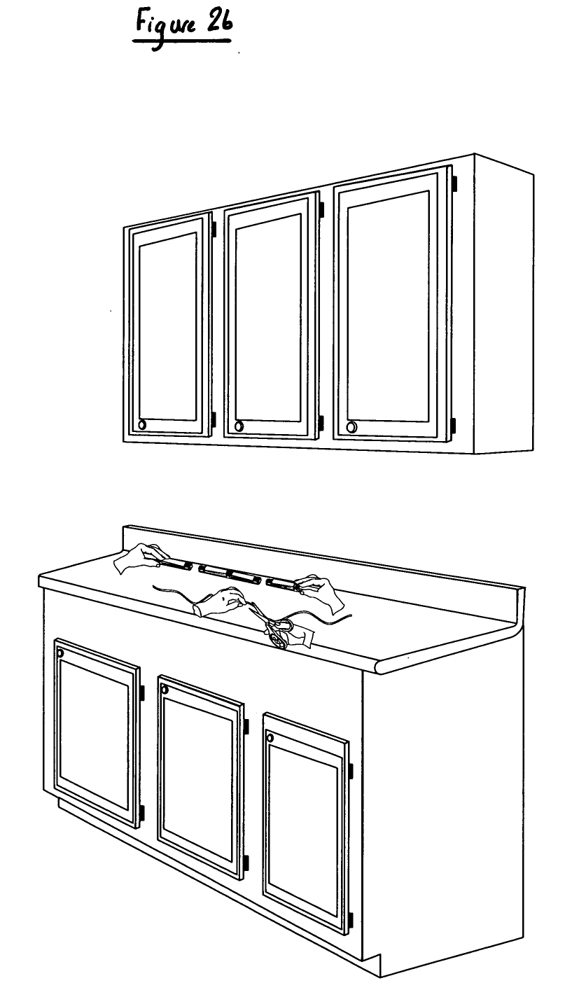

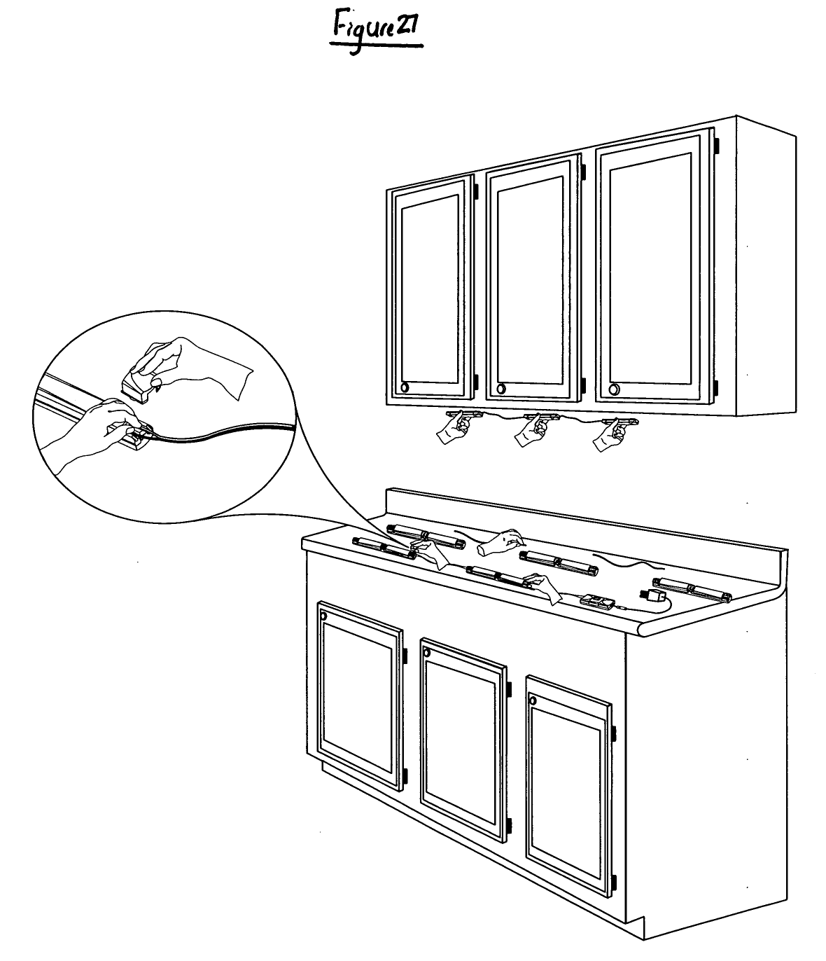

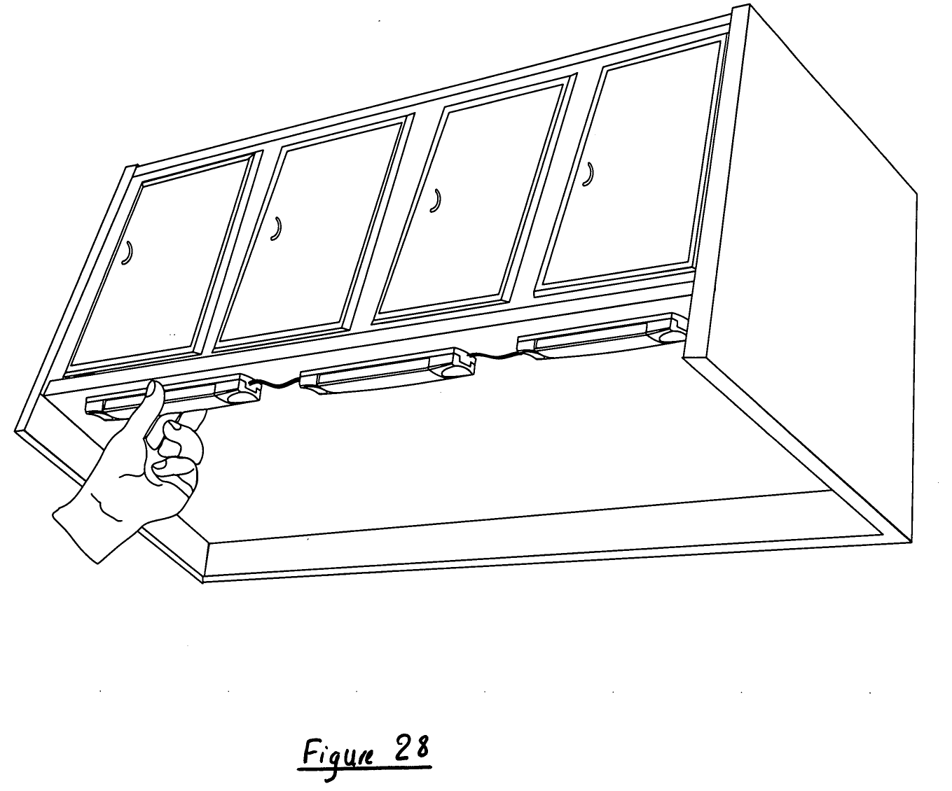

In a second embodiment of the Device 10 in accordance with the present invention, which appears in FIG. 1, the LED segment 30 of FIGS. 13-27 comprises a printed circuit board (PCB) strip 40, multiple LEDs 50 and at least one pair of terminals 60 fixedly mounted on the top side of the PCB strip 40, a mounting base 100 having a proximate side 102 and a distal side 104, mounting tape 70 bearing a protective covering, on the proximate side 102, a blinder cover 80, and at least one wire management endclip 104.

The PCB strip 40 is frictionally secured on and supported by said mounting base 100. On the distal side of the PCB strip 40 are fixedly secured at least one pair of terminals 60. However, the terminals 60 of the second embodiment do not comprise typical screw type terminals. Rather, each terminal 60 comprises a fork-shaped or u-shaped receiving body having an inner end and an outer end. The base of the u-shaped receiving body is fixed on the PCB strip 40 and its prongs rise vertically upward and distally away from the base of the terminal 60. Said inner end of said terminal 60 is provided with a vertical groove or blades capable of cutting through the jumping wires 90's insulation, after the wires are punched down into the terminal 60.

The jumping wires 90 are received by said u-shaped, open top terminals 60. Thereafter, they are covered with a wire management endclips 104 which aligns said jumping wires 90 and is secured into the mounting base 100.

Said blinder cover 80 comprises at least one blinder cover segment 82 and at least one wire driver endcap 84. After the wire management end clip 104 is secured on the mounting base 100, both the blinder cover segment 82 and the wire driver endcap 84 are placed on top of the PCB strip 40 bearing the wire management end clips 104 and pushed down until they click into place on the mounting base 100. The combinations of the terminals 60, with the wire management end clips 104 and the blind cover wire driver endcaps 84 act as insulation-displacement connectors so that the insulation need not be removed from the wire.

The process for connecting and installing the Device 10 as for example on the underside of cabinetry, is shown in FIGS. 26 and 27 and includes the following steps: a) measure the area and determine how many LED segments will be used. The under cabinet length is approximately two feet. Two light segments of 12 inches each may be needed to properly light this area; b) place the two segments on top of the counter directly underneath the area where the segments will be placed. Don't peel the backing; c) Using 4″ pre-cut wires connect the two segments; If more than two segments are needed simply follow the steps and add on more segments; d) Once the segments are connected negative terminal to negative terminal and positive terminal to positive terminal, mark with a pencil the locations where the segments will be installed under the cabinet; e) connect the output wire of the transformer to the first segment; f) peel the protective covering off the back of the segment furthest away from the transformer and adhere in place; g) take the next light segment—pull tightly, peel and place in next location; (h) once the segments are all installed close the circuit by hitting the toggle switch. The current flowing through the closed circuit will turn on the LEDs and flood the area with light.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

Accordingly, we claim:

1. A modular, expandable lighting system comprising at least one light emitting diode segment having at least one printed circuit board, at least one light emitting diode and at least one pair of terminals connected to said printed circuit board and means for fixedly but removable fastening and mounting said light emitting diode segment with ease in tight spaces.
